(19) United States
(12) Patent Application Publication
(10) Pub. No.: US 2020/0185939 A1
(43) Pub. Date: Jun. 11, 2020

(54) VEHICLE WITH MOBILE ELECTRONIC DEVICE CHARGER

(71) Applicants: Lloyd Gladstone, Edison, NJ (US); Eddie Jemal, Edison, NJ (US); Ralph Sasson, Edison, NJ (US); Jeffrey Saka, Edison, NJ (US)

(72) Inventors: Lloyd Gladstone, Edison, NJ (US); Eddie Jemal, Edison, NJ (US); Ralph Sasson, Edison, NJ (US); Jeffrey Saka, Edison, NJ (US)

(21) Appl. No.: 16/709,080

(22) Filed: Dec. 10, 2019

Related U.S. Application Data
(60) Provisional application No. 62/777,345, filed on Dec. 10, 2018.

(51) Int. Cl. H02J 7/00; H02J 50/00; B62K 11/14; G07C 5/08

(52) U.S. Cl. CPC H02J 7/0044; H02J 50/005; B62K 2202/00; G07C 5/0816; B62K 11/14

(57) ABSTRACT

The present invention relates to a vehicle including an adjustable charging mount for a mobile electronic device where the mobile electronic device provides performance information related to operation of the vehicle.

### CROSS-REFERENCE TO RELATED APPLICATIONS

The present application claims benefit of and priority to U.S. Provisional Patent Application Ser. No. 62/777,345 entitled VEHICLE WITH MOBILE ELECTRONIC DEVICE CHARGER filed Dec. 10, 2018, the entire content of which is hereby incorporated by reference herein.

### FIELD OF THE DISCLOSURE

The present invention generally relates to a vehicle including an integrated charger for a mobile electronic device. In embodiments, the present invention relates to a vehicle that includes a secure mount for a mobile electronic device that provides wireless and/or wired charging of the mobile electronic device.

### BACKGROUND

Mobile electronic devices, including smart phones, have become an integral part of everyday life for many people. While these devices are very useful and allow users to easily access information from virtually anywhere, increasing use of these devices quickly depletes battery power. Given the mobile nature of such devices, users are often not in a convenient place when power runs down such that recharging may be difficult.

Accordingly, a technical problem is presented in that frequent use of mobile electronic devices quickly depletes batteries and the mobile nature of the devices results in depletion in areas or situations where charging is not convenient or possible. Accordingly, it would be beneficial to provide a vehicle that allows for easy and efficient charging of a mobile device that avoids these and other problems.

### SUMMARY

An object of the present invention is to provide a vehicle with a mount for a mobile electronic device to secure the device and provide easy and efficient charging.

A vehicle in accordance with an embodiment of the present disclosure includes: a body; a pair of wheels connected to a bottom surface of the body with a first wheel positioned at a front end of the body and a second wheel positioned at a rear end of the body; a steering column extending upward from the body and rotatable with respect thereto, the steering column operatively connected to the first wheel such that rotation of the steering column turns the first wheel relative to the body; a mounting element, provided at a top of the steering column, the mounting element comprising: a connection element configured to attach the mounting element to the steering column; a charging portion positioned substantially in a center of a top surface of the mounting element and configured to wirelessly recharge a mobile electronic device mounted in the mounting element; a retaining element configured to secure the configured to receive a mobile electronic device; a motor, operatively connected to at least one of the first wheel and the second wheel to selectively rotate the at least one of the first wheel and the second wheel; a power source operatively connected to the motor and to the charging portion of the mounting element to provide power thereto; a control element operatively connected to the motor to selectively provide power to the motor to rotate the at least one of the first wheel and the second wheel; a charging circuit operatively connected to the power source configured to provide power from an external power source to recharge the power source.

In embodiments, the steering column includes a pair of opposed handle bars extending from opposite sides thereof.

In embodiments, the control element is connected to one of the opposed handle bars.

In embodiments, the mounting element is connected to one of the opposed handle bars.

In embodiments, the vehicle includes a light mounted on a front of the steering column.

In embodiments, the light is operatively connected to a controller such that the light is turned on and off based on commands received from the controller.

In embodiments, the controller comprises a processor of the mobile electronic device received in the mounting device.

In embodiments, the controller is operatively connected to a processor of the mobile electronic device received in the mounting device.

In embodiments, the controller is mounted on one of the body and the steering column of the vehicle.

In embodiments, the vehicle includes a speed sensor configured to provide speed information indicative of a speed of the vehicle, wherein the speed information is provided to the controller.

In embodiments, the controller receives location information indicative of a current location of the vehicle from the mobile electronic device and determines speed information indicative of a speed of the vehicle based on the location information.

In embodiments, the controller receives location information indicative a current location of the vehicle and stores the location information.

In embodiments, the controller provides navigation information indicating an intended route for the vehicle based on the location information and prior location information stored by the controller and provides the navigation information to the mobile electronic device for display on a display of the mobile electronic device.

In embodiments, the navigation information is provided by the mobile electronic device and displayed on a display of the mobile electronic device.

In embodiments, speed information indicative of a speed of the vehicle is determined by the mobile electronic device and displayed on a display of the mobile electronic device.

In embodiments, the vehicle includes a charging port operably connected to the charging circuit and configured to receive a plug connected to the external power source.

In embodiments, the vehicle includes a transceiver operably connected to the controller such that data is received by and transmitted from the controller.

In embodiments, the controller receives instruction information from the mobile electronic device and provides instructions to one or more of the motor charging source and power source based on the instruction information.

In embodiments, the controller provides to the mobile electronic device at least one of speed information, location information, light information and power source status information to the mobile electronic device.

In embodiments, the mounting device is configured to receive the mobile electronic device without blocking a camera lens integrated into the mobile electronic device.

In embodiments, the vehicle includes a brake element configured to slow the vehicle.

In embodiments, the vehicle includes a brake light wherein the brake light is activated when the brake element is activated.

In embodiments, the vehicle includes a brake actuator positioned on at least one of the opposed handle bars and operably connected to the brake element to selectively engage the brake element.

In embodiments, the brake actuator is operable connected to the controller and the controller sends instructions to the brake element based on input provided by the brake actuator.

In embodiments, the connection element is a hinge.

This and other objects shall be addressed by embodiments of the present invention as set forth herein.

### BRIEF DESCRIPTION OF THE DRAWINGS

Exemplary embodiments of the present invention will be described with references to the accompanying figures, wherein:

FIG. 1A is an exemplary illustration of a vehicle in accordance with an embodiment of the present disclosure;

FIG. 1B is a bottom perspective view of the vehicle of FIG. 1 in accordance with an embodiment of the present disclosure;

FIG. 1C is a detailed perspective view of a front of the vehicle of FIG. 1 in accordance with an embodiment of the present disclosure;

FIG. 1D is a detailed view of a bottom portion of the front of the vehicle of FIG. 1 in accordance with an embodiment of the present disclosure;

FIG. 2A is a detailed view of a charging mount provided on the vehicle of FIG. 1 in accordance with an embodiment of the present disclosure;

FIG. 2B illustrates a detailed view of a charging mount provided on the vehicle of FIG. 1 in accordance with another embodiment of the present disclosure;

FIG. 2C illustrates a detailed view of a charging mount provided on the vehicle of FIG. 1 in accordance with another embodiment of the present disclosure;

FIG. 2D illustrates a detailed view of a charging mount provided on the vehicle of FIG. 1 in accordance with another embodiment of the present disclosure;

FIG. 2E illustrates a detailed view of a charging mount provided on the vehicle of FIG. 1 in accordance with another embodiment of the present disclosure;

FIG. 2F illustrates a detailed view of a charging mount provided on the vehicle of FIG. 1 in accordance with another embodiment of the present disclosure;

FIG. 2G illustrates a detailed view of a charging mount provided on the vehicle of FIG. 1 in accordance with another embodiment of the present disclosure;

FIG. 2H illustrates a detailed view of a charging mount provided on the vehicle of FIG. 1 in accordance with another embodiment of the present disclosure;

FIG. 3 is an exemplary circuit diagram for a USB charging receptacle suitable for use in the vehicle of FIG. 1 in accordance with an embodiment of the present disclosure;

FIG. 4A, 4B, 4C is an exemplary circuit diagram of a wireless charging plate suitable for use in the vehicle of FIG. 1 in accordance with an embodiment of the present disclosure;

FIG. 5 is an exemplary circuit diagram of an application circuit suitable for use with a Bluetooth enabled chip suitable for use in the vehicle of FIG. 1 in accordance with an embodiment of the present disclosure;

FIG. 6 is an exemplary block diagram of the vehicle of FIG. 1 in accordance with an embodiment of the present disclosure;

FIG. 7 illustrates a detailed view of a charging mount provided on the vehicle of FIG. 1 in accordance with an embodiment of the present disclosure;

FIG. 7A illustrates a detailed view of the charging mount of FIG. 7 with the movable arms in an extended position;

FIG. 7B illustrates a detailed view of the charging mount of FIG. 7 positioned in a horizontal orientation;

FIG. 8 illustrates a detailed view of a charging mount provided on the vehicle of FIG. 1 in accordance with an embodiment of the present disclosure; and

FIG. 8A illustrates a more detailed view of the charging mount of FIG. 8 positioned in a horizontal orientation.

### DETAILED DESCRIPTION

The present invention generally relates to a vehicle suitable for use by at least one user. In embodiments, the present invention generally relates to a vehicle for use by at least one user that includes a mount for a portable electronic device with a charging component.

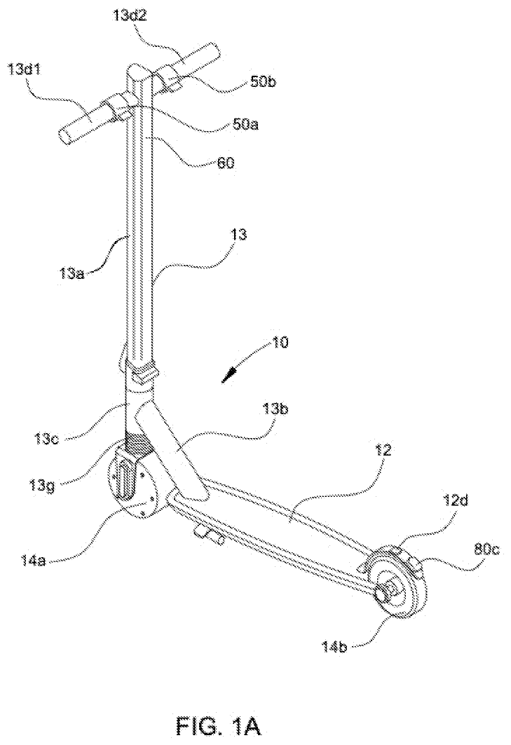

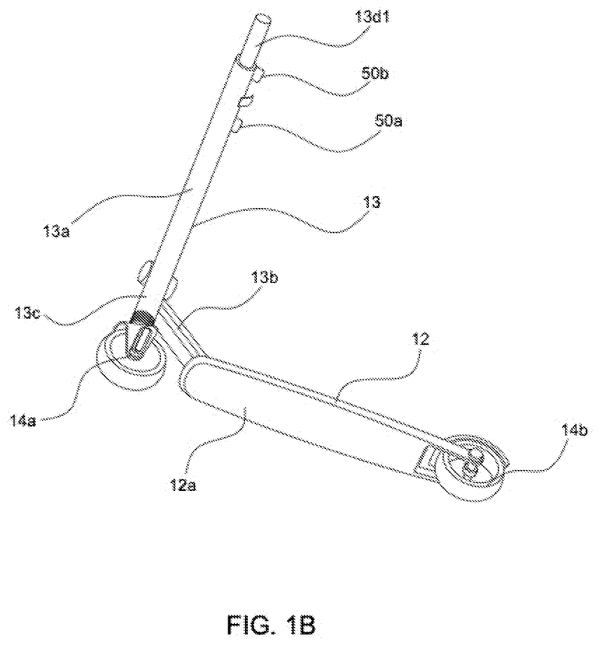

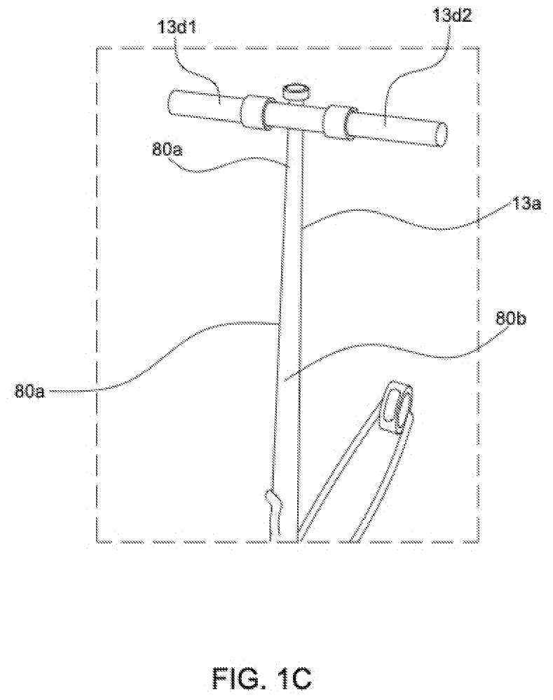

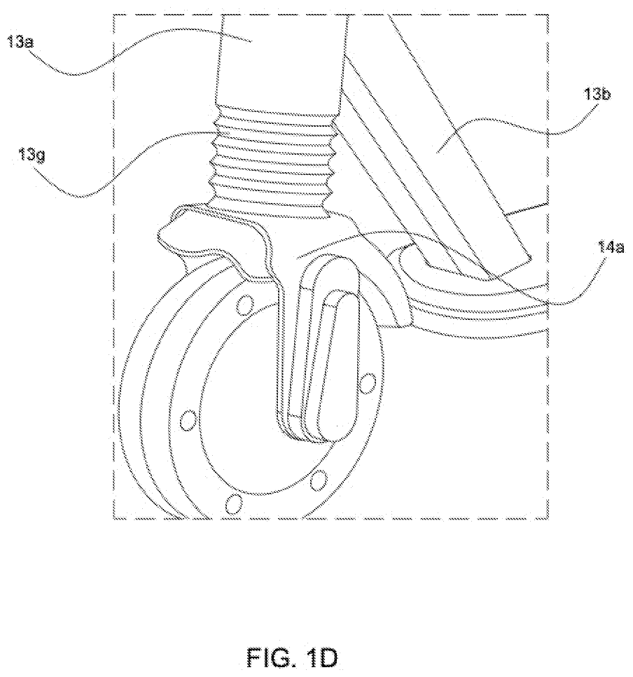

FIG. 1A illustrates an exemplary vehicle 10 in accordance with an embodiment of the present disclosure. In embodiments, the vehicle 10 is a scooter and includes a base 12 with at least a rear wheel 14b provided at a rear end thereof. In embodiments, the base 12 is an elongated structure with the rear wheel 14b attached at the rear end and a steering assembly 13 attached to the front end. In embodiments, the base 12 may be made of wood, plastic, metal, or any other suitably durable material. In embodiments, the base 12 may be made of a combination of wood, plastic, metal, and any/or other suitably durable material.

In embodiments, the base 12 may include a compartment with a cover 12a (see FIG. 1B, for example). In embodiments, the compartment may include one or more electric motor(s) 30 that may be used to propel the vehicle 10. In embodiments, the compartment may include one or more power element(s) 32 that may provide electric power for the vehicle 10, including the motor(s) 30. In embodiments, the compartment may include a controller 34 to control operation of the motor(s) 30 and/or power element(s) 32. In embodiments, the motor(s) 30, power element(s) 32 and controller 34 may be incorporated into the base 12, but not positioned in a separate compartment.

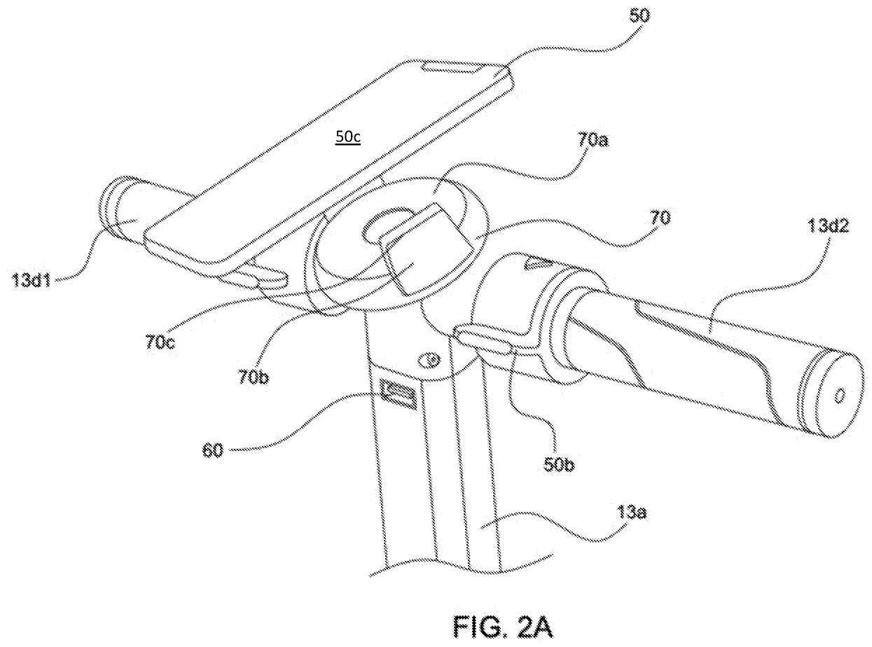

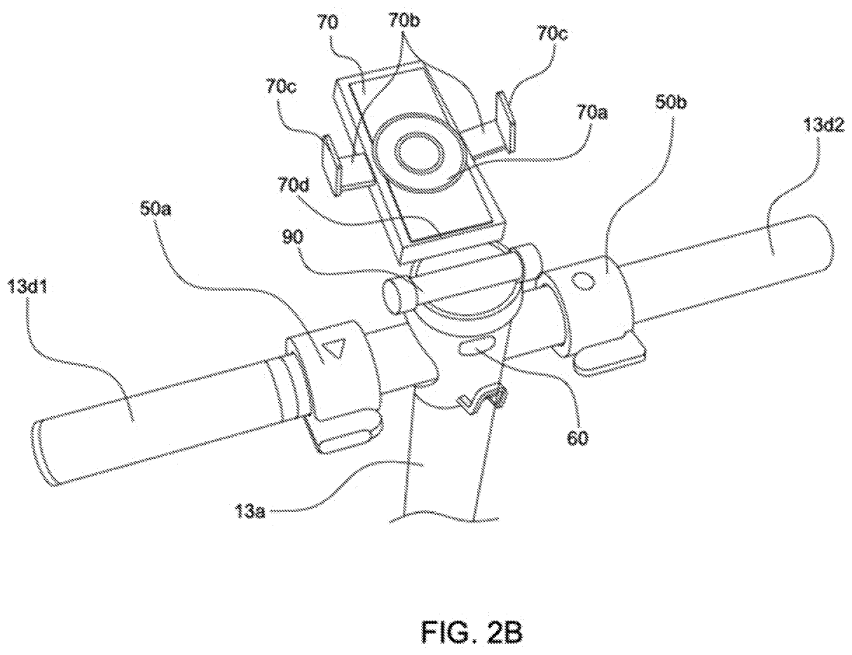

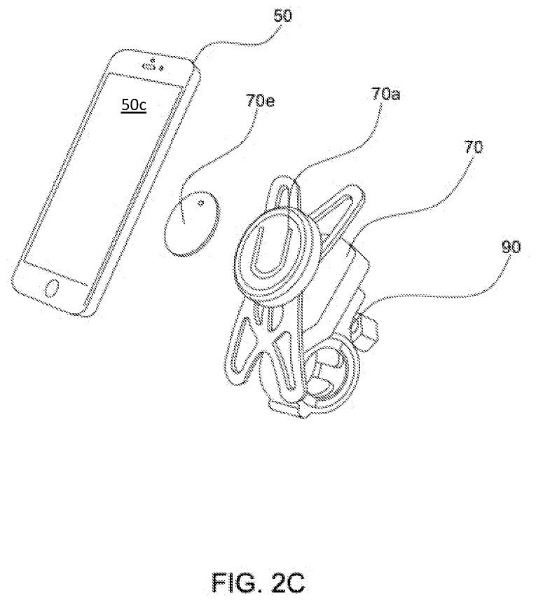

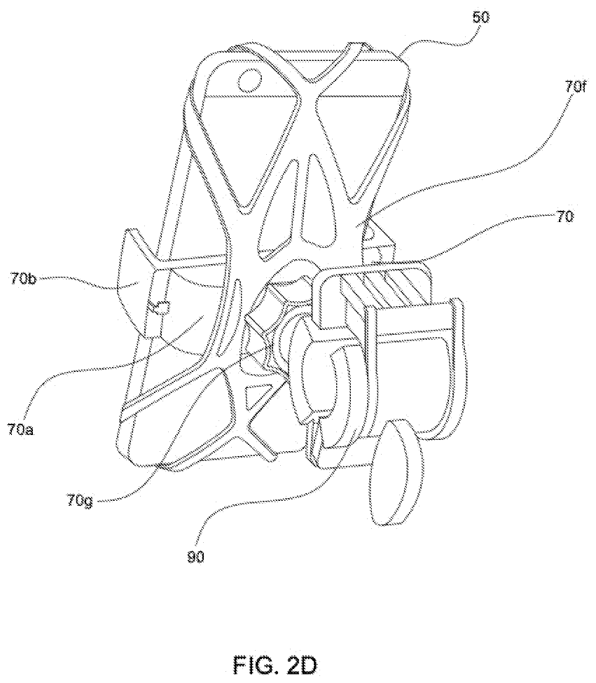

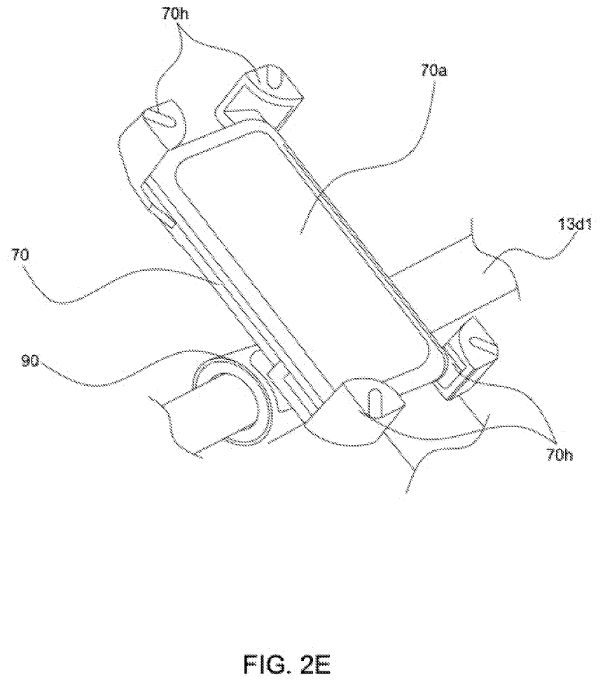

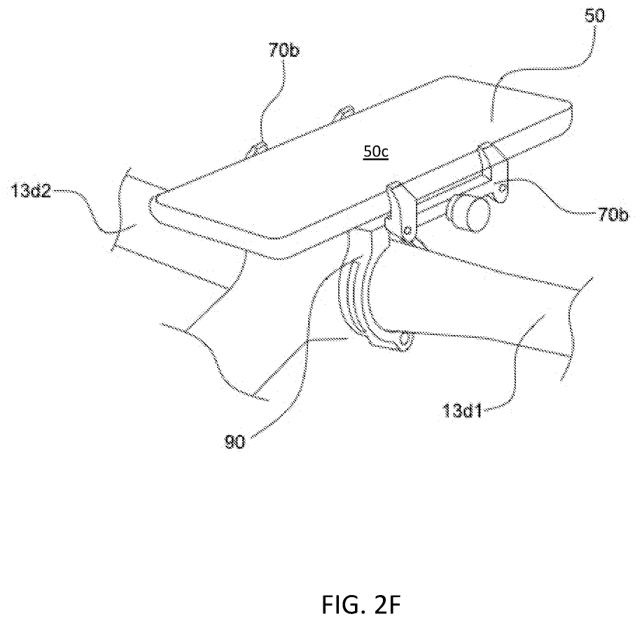

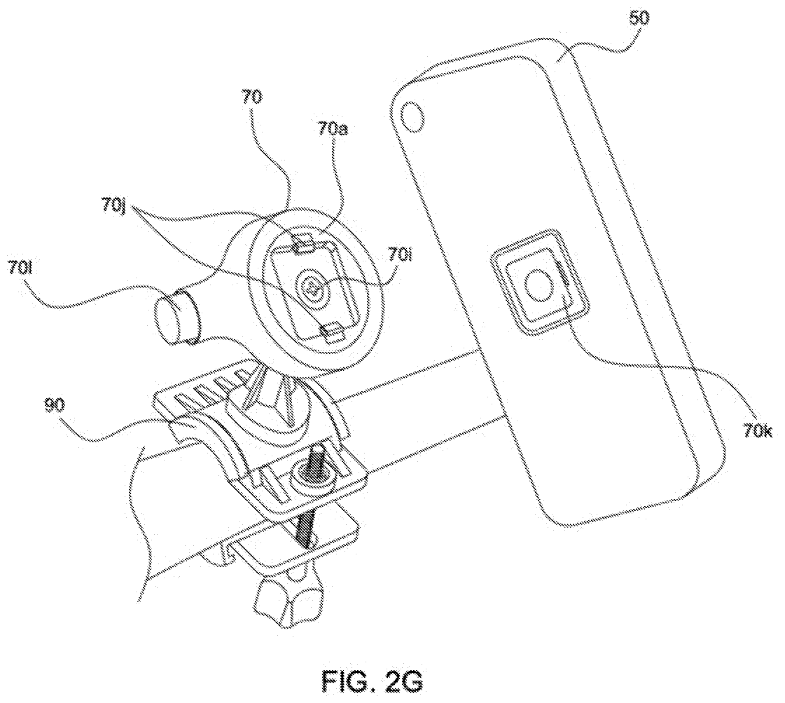

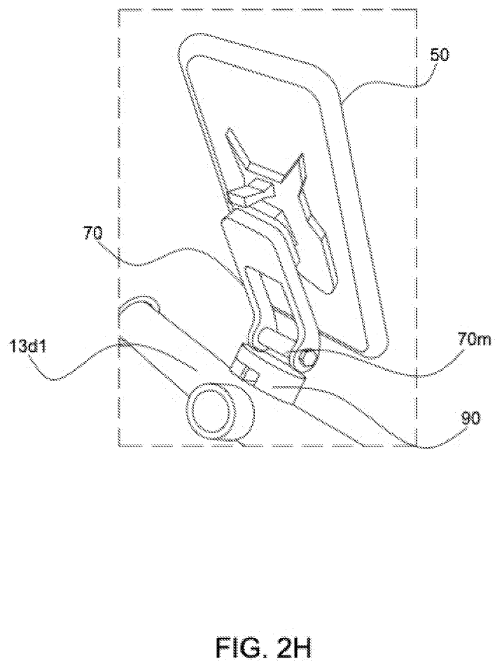

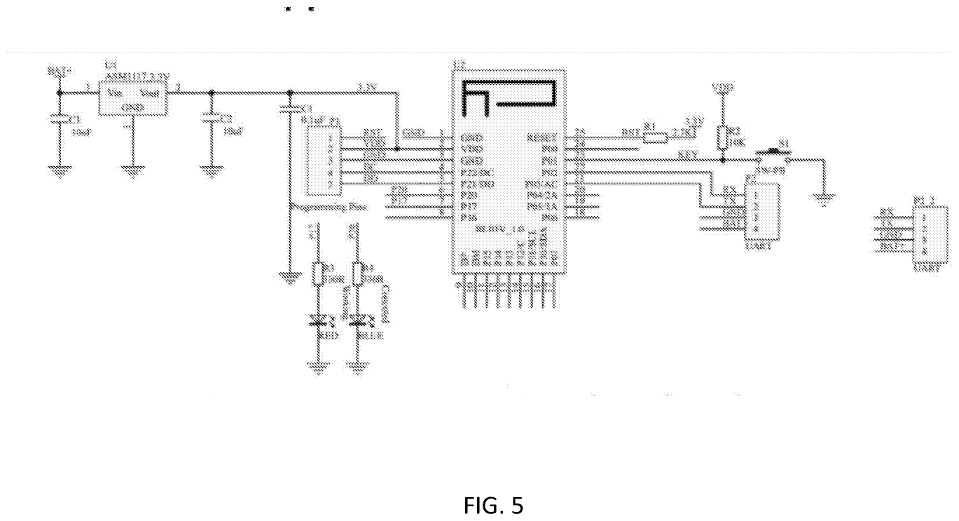

In embodiments, a transceiver 36 may be provided in the compartment or otherwise incorporated into the base 12 to transmit and/or receive information via wireless transmission and reception. In embodiments, this information may be provided to or from the controller 34 and may include instructions regarding operation of the vehicle 10. In embodiments, the controller 34 may generate performance information regarding performance or status of the vehicle 10. In embodiments, the performance information may include data which indicates a current speed and/or current power level, to name a few. In embodiments, the performance information may be stored in a memory (not shown) associated with and/or operatively connected to the controller 34. In embodiments, the performance information may be presented to a user of the vehicle 10 via a display (not shown) that may be provided on the vehicle 10. In embodiments, the performance information may be transmitted to a user mobile electronic device 50 (see FIG. 2A, for example) via either a wired or wireless connection and displayed on a display 50c of the device 50. In embodiments, the transceiver 36 may be incorporated into the controller 34. In embodiments, the transceiver 36 may be physically separate from, but operatively connected to the controller 34. In embodiments the transceiver 36 may be a Bluetooth transceiver. In embodiments, the transceiver 36 may communicate via WiFi, WAN and/or LAN, to name a few. FIG. 5 illustrates an exemplary application circuit using a Bluetooth enabled transceiver chip suitable for use in the transceiver 36. FIG. 5 illustrates an exemplary circuit and other circuits and/or circuit architectures may be used.

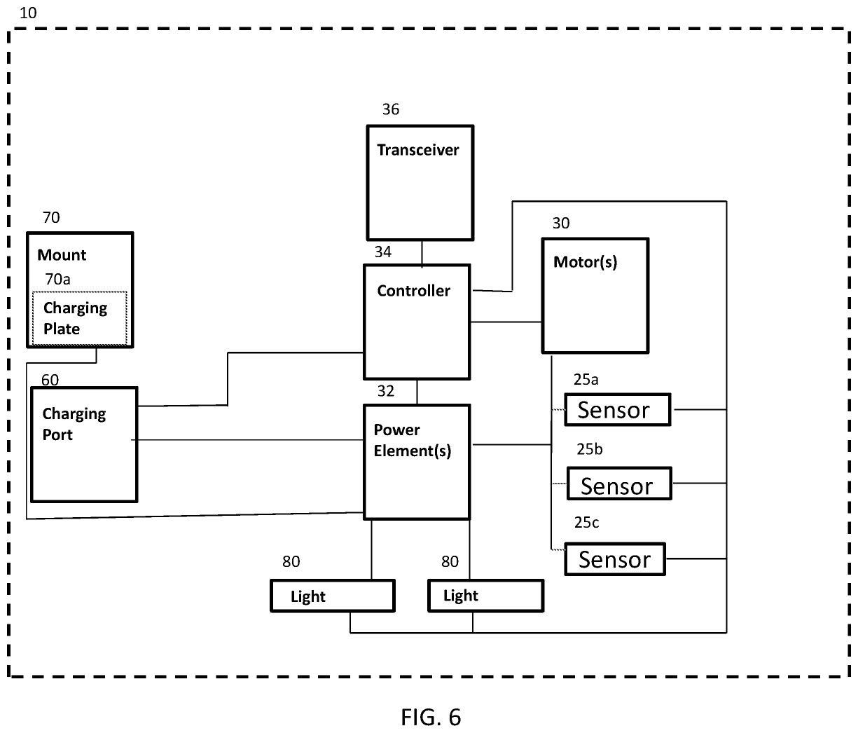

In embodiments, a plurality of sensors 25a, 25b, 25c (see FIG. 6, for example) may be provided in and/or on the vehicle 10 to provide information to the controller 34, which may use the provided information to generate the performance information. In embodiments, a speed sensor (e.g. sensor 25a) may be operable to provide speed information indicating a speed at which the vehicle 10 is travelling. In embodiments, such a speed sensor may monitor rotation of the wheels 14a, 14b and/or may monitor performance of the motor(s) 30 to provide speed information. In embodiments, speed information may be provided by the mobile electronic device 50 via sensors of the mobile electronic device 50. In embodiments, the speed information may be provided to the controller 34 and/or may be displayed to the used on the display 50c of the mobile electronic device 50. In embodiments, a voltage sensor (e.g. sensor 25b) may provide information regarding a charge level of the power element(s) 32. In embodiments, voltage information may be computed by the mobile electronic device 50 based on speed and location information to provide an estimate of the charge level of the power element(s) 32. In embodiments, the charge information may be sent to the controller 34 and/or may be displayed on the display 50c. In embodiments, one or more temperature sensor(s) (e.g. sensor 25c) may provide information regarding temperature of components of the vehicle 10, such as the motor(s) 30 or the controller 34, to name a few. In embodiments, additional sensors 25 may be provided, if desired, to monitor other aspects and parameters of the vehicle 10 and its performance or position. In embodiments, one or more location sensor(s) may provide information regarding the location of the vehicle 10.

Referring to FIG. 1A, in embodiments, the steering assembly 13 may include and/or be operatively connected to the front wheel 14a and may be connected to the base 12 such that the front wheel 14a may be turned to the left and right relative to the base 12. In embodiments, the steering assembly 13 may include a vertical steering shaft 13a that extends upward from the front wheel 14a. In embodiments, the vertical steering shaft 13a is connected to a front end of the base 12 (e.g. the end of the base 12 adjacent to the front wheel 14a). In embodiments, a connector 13b may connect the vertical steering assembly 13a to the base 12. In embodiments, the connector 13b may include and/or be operatively connected to a collar portion 13c through which the vertical steering shaft 13a passes such that the vertical steering shaft 13a is able to rotate from side to side, while securing the steering assembly 13 to the base 12. In embodiments, a suspension element 13g may be connected to a bottom end of the steering shaft 13a, between the steering shaft 13a and the front wheel 14a to absorb shock (see FIG. 1D, for example). In embodiments, the steering assembly 13 may fold up such that it is adjacent to the base 12 to make the vehicle 10 more compact and easier to carry or store. In embodiments, the steering assembly may be operatively connected to the rear wheel 14b. In embodiments, side-to-side movement may include one or more of the following: a 90 degree rotation, a 180 degree rotation, and/or a 360 degree rotation, to name a few.

In embodiments, a set of handlebars 13d1, 13d2 may be provided at a top of the vertical steering shaft 13a. In embodiments, the handlebars 13d1, 13d2 may form a general T-shape with respect to the top end of the vertical steering shaft 13a. In embodiments, the handle bars 13d1, 13d2 extend away from each other in substantially opposite directions. In embodiments, the handlebars 13d1, 13d2 may form a general U-shape or V-shape, to name a few. In embodiments, one or more actuators 50a, 50b may be mounted on the handlebars 13d1, 13d2. In embodiments one of the one or more actuators 50a, 50b may be used as a throttle to increase speed of the vehicle 10. In embodiments, one of the actuators 50a, 50b may be used to decrease the speed of the vehicle 10. In embodiments, the actuators 50a, 50b are operatively connected to the controller 34. In embodiments, the controller 34 may generate control signals based on input information provided from the actuators 50a, 50b. In embodiments, the control signals may be provided to the motor 30, to speed up or slow down the vehicle. In embodiments, control signals may be provided to a braking element (not shown) to slow down the vehicle 10. In embodiments, the braking mechanism may be positioned adjacent to one or both of the wheels 14a, 14b to selectively contact at least one of the wheels to slow its rotation. In embodiments, additional actuators may be provided if desired. In embodiments, there may be no actuators included. In embodiments, the vehicle 10 may include only one actuator.

In embodiments, the base 12 may include manual braking element 12d that extends over a top surface of the rear wheel 14b (and/or front wheel 14a). In embodiments, a user may press down on manual braking element 12d to contact the rear wheel such that the friction between the rear wheel 14b and the braking element 12d causes the vehicle 10 to decrease in speed. In embodiments, braking may be provided automatically based on instructions from the controller 34 and braking element 12d.

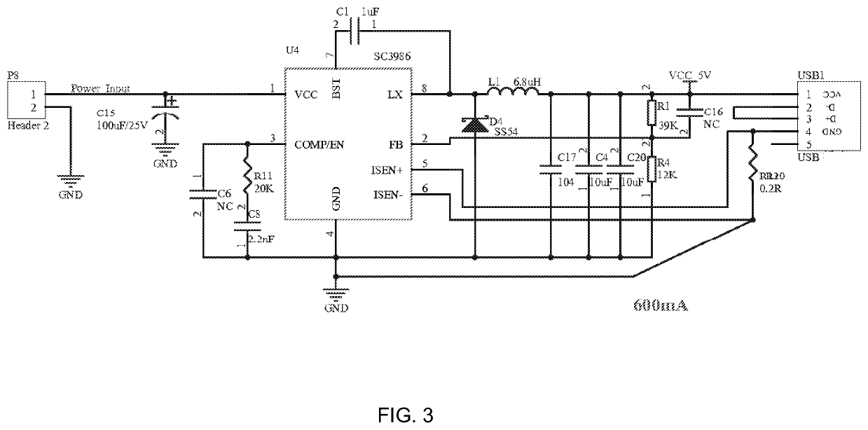

In embodiments, the vertical steering shaft 13a may include a charging port 60, preferably positioned near a top end of the vertical steering shaft 13a. In embodiments, the charging port 60 may be a USB port. FIG. 3 illustrates an exemplary USB port 60 and an exemplary circuit diagram of circuitry associated therewith suitable for use in the charging port 60. It is noted that FIG. 3 illustrates an exemplary circuit architecture for the charging port 60 and others may be used. While a USB charging port is illustrated, the vehicle 10 may include additional or alternative charging ports based on one or more different connections. In embodiments, the charging port 60 may be connected to the power element(s) 32 and/or to the controller 34. In embodiments, the charging port 60 may receive a USB connector to provide a wired connection to the mobile electronic device 50 to provide for recharging thereof from an external power source. In embodiments, the charging port 60 may also be used to receive information from and/or provide information to the mobile electronic device 50. In embodiments, the charging port 60 is not limited to the use of USB connectors and may be adapted for use with other connectors as desired.

In embodiments, a mounting element 70 may be provided on the vertical steering shaft 13a as can be seen in FIGS. 2A and 2B, for example. Referring to FIG. 2A, in embodiments, the mounting element 70 may include a charging plate or portion 70a and a pair of adjustable arms 70b extending from opposite sides thereof. In embodiments, the arms 70b are adjustable from a closed position, in which an end of each arm 70b is substantially adjacent to the edge of the charging plate 70a, and an open position, in which the arms 70b are extended outward in opposite directions away from the charging plate 70a. In embodiments, the arms 70b may extend from the top and bottom ends of the mounting element 70 rather than from the sides. In embodiments, the arms 70b are biased into the closed position. In embodiments, the end of each arm 70b includes a bracket 70c that extends outward from the end of the arm 70b toward a user. In embodiments, each bracket 70c may be angled inward towards the mounting element 70. In embodiments, a cushion or grip element may be provided on an inner surface of each bracket 70c.

FIG. 2B illustrates an embodiment of the mounting element 70 that includes the charging plate or portion 70a, arms 70b, and brackets 70c, which may operate in substantially the similar manner as described above in connection with FIG. 2A, the description of which applying herein. In addition, a support ledge 70d may be provided on a bottom edge to support a bottom of the mobile electronic device 50.

In operation, a user of the vehicle 10 may secure the mobile electronic device 50 to the mounting element 70. In embodiments, the user extends the arms 70b such that there is sufficient room to place the mobile electronic device 50 between the arms 70b. The brackets 70c and/or the grip elements contact the sides of the mobile device 50 and hold it in place adjacent to and in contact with the charging plate 70a. In embodiments, the arms 70b are biased into the closed position, which may create sufficient force to hold the mobile electronic device 50 securely in the mounting element 70 while the vehicle 10 is in motion. The grip elements may provide a high friction surface which reduces the danger of the mobile electronic device 50 slipping out of the mounting element 70.

In embodiments, the mobile electronic device 50 may be charged using a charging wire (not shown) connected to the charging port 60. In embodiments, the wire may also be used to provide information to and/or receive information from the mobile electronic device 50, such as the performance information discussed above. In embodiments, the performance information may be displayed to a user via display 50c of the mobile electronic device 50. In embodiments, the mobile electronic device 50 may include a dedicated software application to facilitate the connection with the vehicle 10. In embodiments, the mobile electronic device 50 may be used to provide instructions to the controller 34, for example, to increase the speed of the vehicle 10 or to decrease the speed of the vehicle 10. In embodiments, the mobile electronic device 50 may include software to render a graphical user interface to aid the user in viewing information derived by the vehicle 10 or sending information to the vehicle 10 as is discussed further below.

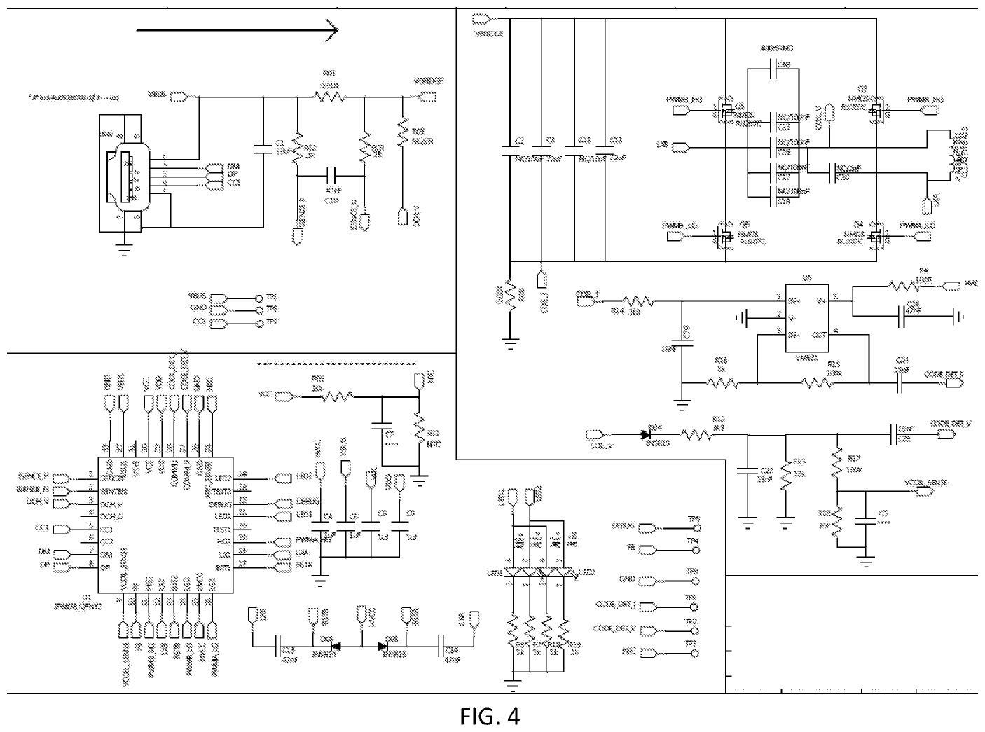

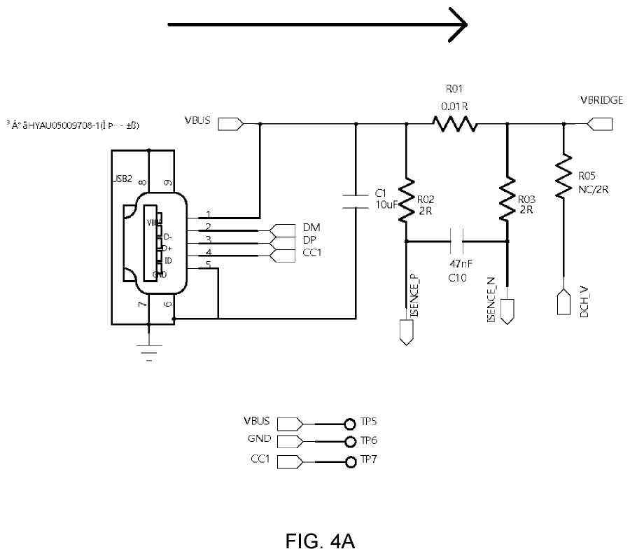

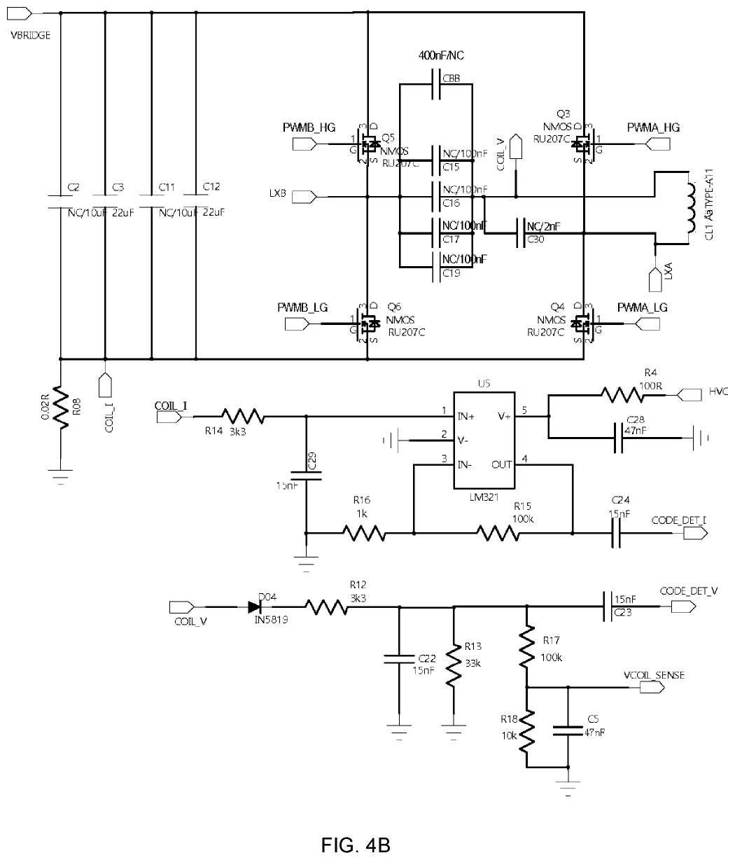

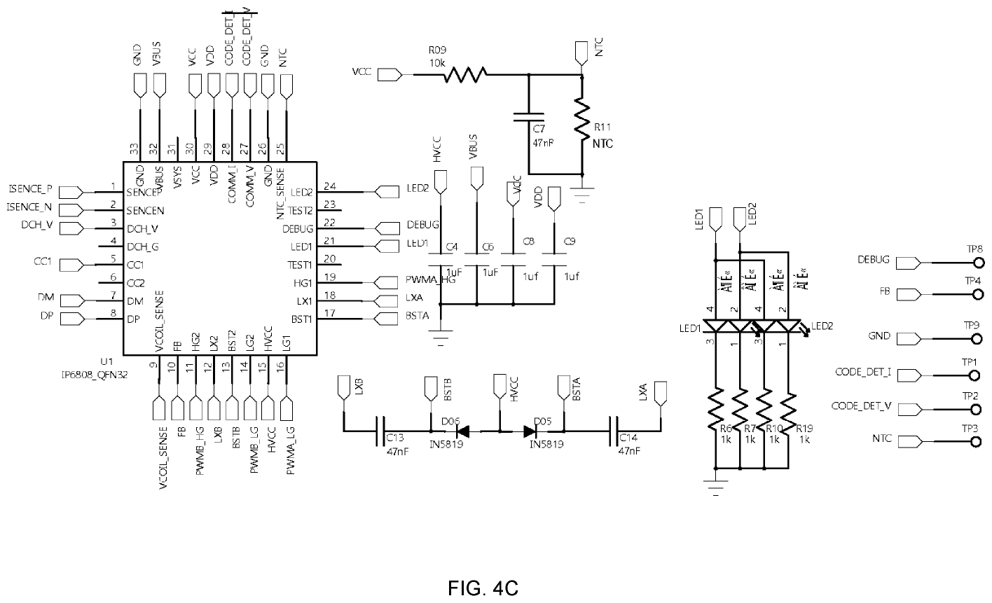

In embodiments, the mobile electronic device 50 may be charged wirelessly (e.g. via the charging plate or portion 70a of the mount 70) without the need for a wire connection between the mobile electronic device 50 and the vehicle 10. In embodiments, the charging plate 70a provides a magnetic field, which, when the mobile electronic device 50 contacts it, induces current in the mobile electronic device that may be used to charge it. In embodiments, the charging plate 70a and the mobile electronic device 50 may provide charging based on the Qi standard, however, any suitable wireless charging protocol or standard may be used. FIG. 4A, 4B, 4C illustrates an exemplary circuit diagram of a suitable circuit for use in the charging plate 70a. It is noted that FIG. 4A, 4B, 4C merely illustrates an exemplary circuit and other suitable circuit architectures may be used.

In embodiments, the mobile electronic device 50 may communicate with the vehicle 10 wirelessly. As noted above, in embodiments, the vehicle 10 includes a transceiver 36 that is operable to send and receive information wirelessly. In embodiments, the mobile electronic device 50 may communicate with the controller 34, for example, to exchange information wirelessly via the transceiver 36. In embodiments, the mobile device 50 may receive performance information from the controller 34 and display it to a user via display 50c of the mobile electronic device 50. The mobile electronic device 50 may transmit information to the controller 34 wirelessly via the transceiver 36. As noted above, in embodiments, the mobile electronic device 50 may include a software application to facilitate this communication and data display. In embodiments, the mobile device and/or the software application may be used to illustrate navigation information to aid a user in finding a location as well as real time location information. In embodiments, the mobile electronic device 50 and/or the software application may be used to photograph or take video as the user is travelling and the user may toggle between a camera view and a dashboard view in which performance information may be displayed. In embodiments the performance information may be used to determine a maximum range available for the vehicle 10. In embodiments, where a selected destination is indicated in a navigation mode, an alert may be issued if the destination is beyond the range of the vehicle. In embodiments, the mobile electronic device 50 may provide instructions to the controller 34 wirelessly. In embodiments, the instructions may be used by the controller 34 to generate control signals to provide for acceleration or braking of the vehicle 10 or other functions.

In embodiments, the mobile electronic device 50 may provide performance information. In embodiments, the mobile device 50 may provide speed data indicative of a speed at which the mobile electronic device 50, and, therefore, the vehicle 10 is travelling. In embodiments, the mobile electronic device 50 may include GPS capabilities which may allow for providing speed data. In embodiments, the GPS capabilities included in the mobile device may also be used for navigation to set desired routes that may be displayed to the user.

FIG. 2B illustrates an exemplary connection element 90 that may be used to connect the mounting element 70 to the steering shaft 13a. In embodiments, the connection element 90 may be a hinge that allows the mounting element 70 to adjust at least one of the pitch, yaw, and/or roll of the mounting element 70, as desired. In embodiments, the connection element 90 may allow the mounting element 70 to be adjustably secured to the vertical steering shaft 13a such that the mobile electronic device 50 may be moved relative to the vertical steering shaft 13a while secured in the mount. In embodiments, the connection element 90 allows the mounting element 70 to rotate at least upward and downward. In embodiments, connection element 90 enables the mounting element 70 to be rotatable about at least two axes. In embodiments, the mounting element 70 may be secured to the vertical steering shaft 13a using a connection element 90 in the form of a ball joint to allow for movement in multiple directions. In embodiments, the mounting element 70 may be adjusted to a desired position and then remain in the that position using the connection element 90. In embodiments, the mounting element 70 may maintain a desired position via a friction fit. In embodiments, the mounting element 70 may maintain a desired position by activating a locking mechanism. In embodiments, the connection element 90 may be integrated into the vertical steering shaft 13a as illustrated in FIG. 2B, for example. In embodiments, the connection element 90 may be attached to the vertical steering shaft 13a. In embodiments, the connection element 90 may be attached to the handlebars 13d1, 13d2 or a portion thereof.

In embodiments, the mounting element 70 may use magnetic attraction to hold the mobile device 50 in place, as can be seen in FIG. 2C, for example. In embodiments, the mounting element 70 may not include the arms 70b. In embodiments, a magnetic disk 70e may be secured to the mobile electronic device 50 such that the mobile electronic device 50 is secured to the mounting element 70 via a magnetic field (e.g. between magnetic disk 70e and portion 70a). In embodiments, the connection element 90 may be or include an adjustable clamp that may be secured to either the vertical steering shaft 13a or to a portion of the set of handlebars 13d1, 13d2. The charging plate 70a may be used to charge the mobile electronic device 50.

Referring to FIG. 2D, in embodiments, the mounting element 70 may include flexible straps 70f that may be used to secure the device 50 to the mounting element. In embodiments, the straps 70f may be made of silicone. In embodiments, the straps 70f may be made of any flexible and durable material. In embodiments, the arms 70b may be used as well as the straps 70f to keep the device 50 in place. In embodiments, the arms 70b may be present but have limited adjustability such that the straps 70f keep the device 50 in place. The connection element 90 may be or include an adjustable clamp connecting the mounting element 70 to either the vertical steering shaft 13a or to a portion of the handlebars 13d1, 13d2. The mobile electronic device 50 may be charged via the charging plate 70a. A ball joint 70g may be provided between the connection element 90 and the charging plate 70a to allow the position of the device 50 to be adjusted.

In embodiments, the mounting element 70 may include a set of posts 70h positioned at the four corners thereof to secure the mobile electronic device 50 as can be seen in FIG. 2E, for example. In embodiments, the position of each of the posts 70h may be adjusted to accommodate and/or secure the mobile electronic device 50 adjacent to the charging plate 70a. In this embodiment, the connection element 90 may be or include an adjustable clamp connecting the mounting element 70 to either the vertical steering shaft 13a or to a portion of the handlebars 13d1, 13d2.

In embodiments, the mounting element 70 may be oriented in a more horizontal position as can be seen in FIG. 2F. In embodiments, the connection element 90 may be or include an adjustable clamp that may be attached to a portion of the handle bars 13d1, 13d2.

In embodiments, the mounting element 70 may provide for a snap fit with the mobile electronic device 50 as can be seen in FIG. 2G, for example. In embodiments, the charging plate 70a may include a recess 70i with two movable pins or tabs 70j that are biased inward. In embodiments, more than two movable pins or tabs 70j may be used. In embodiments, the mobile electronic device 50 includes mounting plate 70k, which is connected thereto and configured to be received in the recess 70i where the pins or tabs 70j grasp the edges thereof to hold the mobile electronic device 50 in place. In embodiments, a release button 701 may be provided to release the pins 70j so that the device 50 can be removed from the mounting element 70.

In embodiments, the mounting element 70 may secure the mobile electronic device 50 based on a twist and lock connection as shown in FIG. 2H. In embodiments, the mounting element 70 may be secured to the connection element 90, which may be or include an adjustable clamp, via a simple hinge connection 70m as can be seen in FIG. 2H, allowing the mounting element 70 and mobile device 50 to be rotated at least up and down.

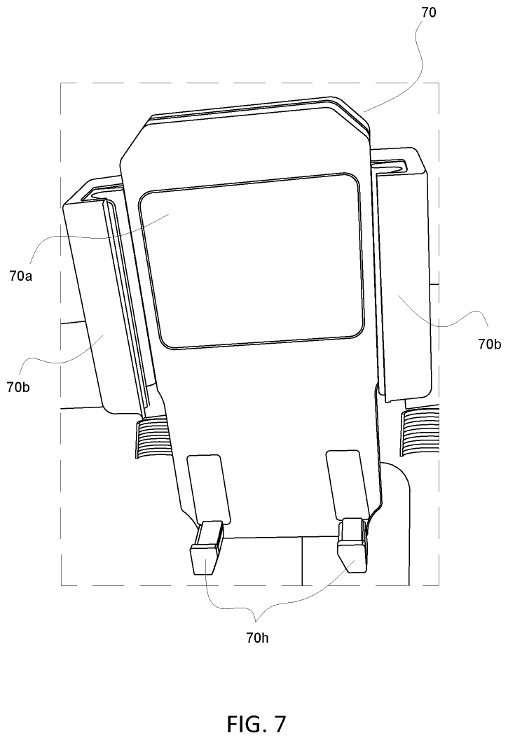

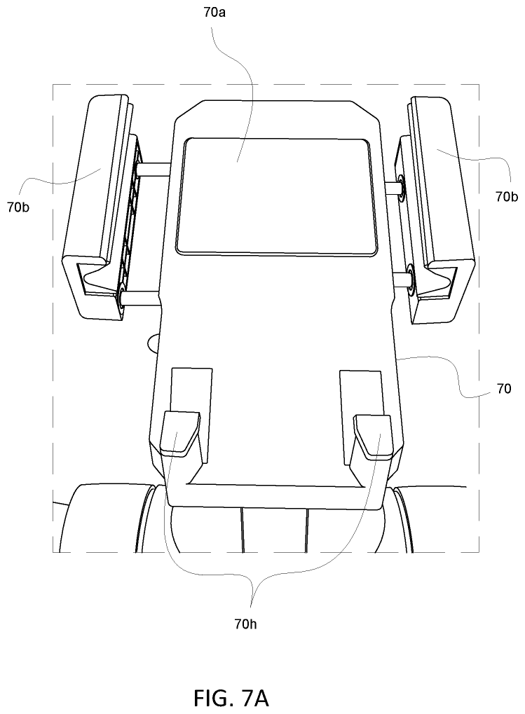

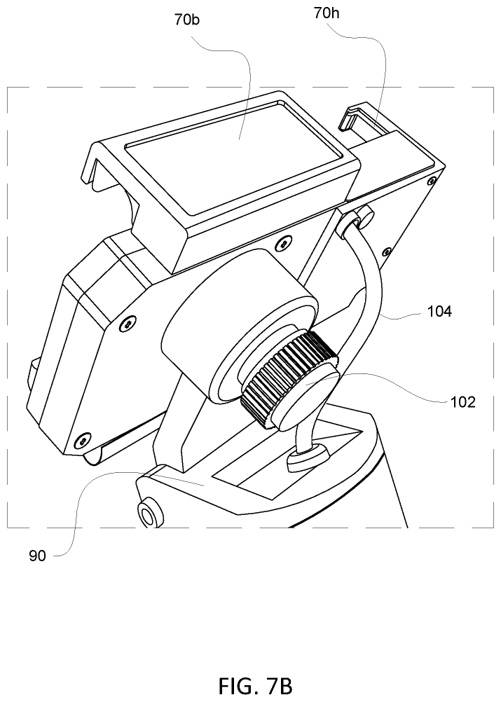

FIG. 7 illustrates another exemplary embodiment of a mounting element 70 suitable for use with the vehicle 10 discussed herein. In embodiments, as illustrated in FIG. 7, the mounting element 70 may include a pair of stationary pegs positioned on a bottom portion of the front surface of the mounting element 70. In embodiments, these pegs support the mobile electronic device 50. In embodiments, the mounting element 70 include movable arms 70b that are provided on either side of the device. These arms are biased inward in a retracted position as illustrated in FIG. 7 and are movable outward in an extended position, as can be seen in FIGS. 7A and 7B, to allow sufficient clearance to accommodate the mobile electronic device 50. In embodiments, the arms 70b are biased inward to the retracted position to secure the mobile electronic device 50 when it is placed in the mounting element 70. In embodiments, the mounting element 70 may be rotated into a horizontal position as illustrated in FIG. 7B for example. In embodiments, the mounting element 70 may be connected to the vertical steering shaft 13a via the connecting element 90, which may be embodied as a hinge 90 to allow the mounting element 70 to tilt upward and downward. In embodiments, the charging plate or portion 70a is provided on a front surface of the mounting element 70 and positioned to be adjacent to the mobile electronic device 50 when the device is received in the mounting device 70 such that the charging portion recharges the mobile device wirelessly.

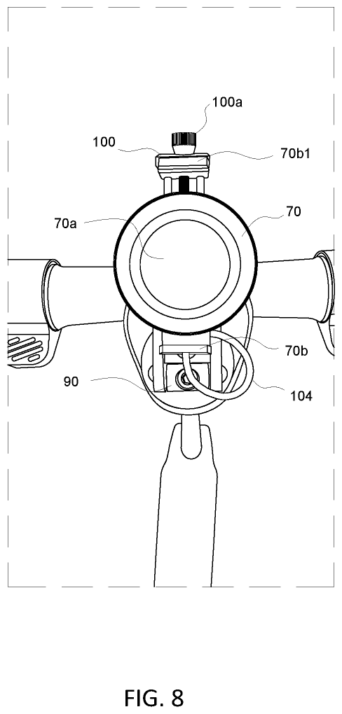

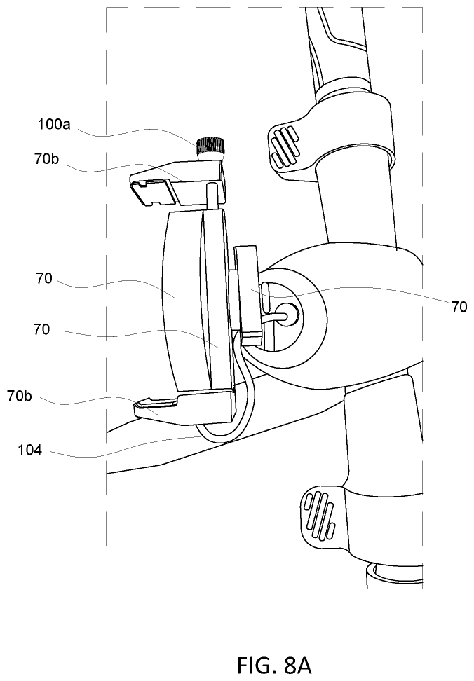

FIG. 8 illustrates another embodiment of the mounting element 70 suitable for use with the vehicle 10. In embodiments, as illustrated in FIG. 8, the mounting element 70 includes a stationary arm 70b with an opposed adjustable arm 70b1 movably mounted opposite the stationary arm 70b. In embodiments, an adjustment element 100 may be provided to adjust a position of the adjustable arm 70b1. In embodiments, the adjustment element 100 may be a knob 100a connected to threaded shaft (not shown) such that rotation of the knob 100a in one direction moves adjustable arm 70b1 in a first direction and rotation of the knob 100a in a second direction, opposite the first moves the arm 70b1 in a second direction (e.g. opposite the first). In embodiments, the position of the adjustable arm 70b1 is set to hold the mobile electronic device 50 firmly in place in the mounting element 70. In embodiments, the mounting element 70 may include a charging portion 70a between the arms 70b and 70b1. In embodiments, the charging portion 70a may be positioned such that it is adjacent to a rear of the mobile electronic device 50 when the mobile device is mounted in the mounting device to provide for charging of the mobile device 50 wirelessly. In embodiments, power may be provided to the charging portion via cable 104. In embodiments a lock element 102 may be provided to lock the mounting element 70 in place and loosened to allow for rotation. In embodiments, the mounting device 70 may be rotated to a horizontal position. In embodiments, the mounting element 70 is configured such that it does not block or disrupt a lens of the mobile electronic device 50.

While various embodiments of the mounting element 70 and connection element 90 are shown and describe herein, the vehicle 10 may include other suitable mounting elements if desired.

Referring to FIG. 1C, in embodiments, the vertical steering shaft 13a may include one or more light element(s) 80 (e.g. lights 80 of FIG. 8, for example) that provide both light for improving vision and improving visibility of the vehicle 10 as well as for aesthetic purposes. In embodiments, the light element(s) 80 may include a headlight 80a as well as a light bar 80b. In embodiments, one or more light elements may be provided on the base 12. In embodiments a brake light 80c may be provided and activated to indicate when a brake is being applied or the vehicle is otherwise slowing.

As described above, FIG. 6 illustrates an exemplary block diagram of the vehicle 10 illustrating the interaction between the components thereof. In embodiments, the power element(s) 32 provide power to the motor(s) 30, the controller 34, the transceiver 36, the charging port 60, and the charging plate 70a as well as to any lighting elements 80 or sensors 25 that are provided on the vehicle 10. In embodiments, the power element(s) 32 may be one or more rechargeable batteries. In embodiments, the base 12 or the power element(s) 32 may include one or more charging circuits to allow for charging of the power element(s) 32. As noted above, in embodiments, the controller 34 may monitor and provide information regarding the charge state of the power elements 32. In embodiments, the controller 34 may provide control signals to control the motor(s) 30. In embodiments, the controller 34 may provide instructions to the power element(s) 32 to control power provided to the motor 30 or other components. In embodiments, the controller 34 may provide control signals to the light elements 80 to turn them on and off. These control signals may be based on user input, via the mobile electronic device 50, for example, or based on environmental conditions. In embodiments, the controller may receive user input and/or instructions from the mobile electronic device via wireless communication using the transceiver 36 discussed above, for example. In embodiments, the sensors 25, may include one or more light sensors that will provide a signal to the controller 34 to indicate when an ambient light level has gone below a predetermined threshold such that the controller will provide a control signal to turn on one or more lighting elements 80. As noted above, in embodiments, the controller 34 may receive user input via the actuators 50a, 50b and may generate control signals based on this input to accelerate and/or brake the vehicle 10, to name a few.

In embodiments, the controller 34 may be included in or operatively connected to the electronic mobile device 50. In embodiments, the controller 34 may be, or may be operatively connected to, one or more processor(s) of the mobile electronic device 50. In embodiments, the controller 34 may be provided in the vehicle 10 and be in communication with the mobile electronic device 50 via a wired or wireless connection. In embodiments, the electronic mobile device 50 may include one or more memory elements operatively connected to the controller 34 and/or the processor of the mobile electronic device 50. In embodiments, the one or more memory elements may include software applications including one or more processor and/or controller executable instructions to provide the graphical user interface on the display 50c of the mobile device 50. In embodiments, the user interface may be provided when a software application on the mobile device is implemented. In embodiments, the user interface may present the vehicle information to the user. In embodiments, the user interface may allow the user to input information or instructions regarding operation of the vehicle. In embodiments, the user may provide input via the display or via verbal commands. In embodiments, the user interface may include one or more fields for input of information or commands from a user. In embodiments, the user interface may be a graphical user interface. In embodiment, the user interface may include icons or buttons that may be used to display different information of to change modes. In embodiments, a navigation mode may be invoked in which a desired route of travel to a destination may be displayed. The navigation information may be provided based on vehicle information and/or position information provided via the mobile electronic device 50, the sensors 25, and/or the controller 34. In embodiments, a camera mode may be initiated in which a camera on the mobile electronic device 50 may be used to capture video, or stills, if desired. As noted above, in embodiments, the mounting device 70 may be connected to the vehicle via a hinge structure 70h to allow for modification of the orientation of the camera.

In embodiments, the vehicle 10 may not include any motors and may be manually powered by a user. In embodiments, even where there is no motor, the vehicle will otherwise operate in substantially the same manner as discussed above.

While the vehicle 10 is illustrated as a scooter in the present application, it is noted that the vehicle 10 may be any suitable vehicular mobile device. In embodiments the vehicle 10 may be an electric scooter, electric bicycle, motorcycle or all-terrain vehicle, to name a few. In embodiments, the mount 70 is mounted as part of or adjacent to a steering mechanism of the vehicle for convenience such that it is easily manipulated by the user's hands which are generally proximate the steering mechanism.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A vehicle comprising:
a body;
a pair of wheels connected to a bottom surface of the body with a first wheel positioned at a front end of the body and a second wheel positioned at a rear end of the body;
a steering column extending upward from the body and rotatable with respect thereto, the steering column operatively connected to the first wheel such that rotation of the steering column turns the first wheel relative to the body;
a mounting element, provided at a top of the steering column, the mounting element comprising:
a connection element configured to attach the mounting element to the steering column;
a charging portion positioned substantially in a center of a top surface of the mounting element and configured to wirelessly recharge a mobile electronic device mounted in the mounting element;
a retaining element configured to secure the configured to receive a mobile electronic device;
a motor, operatively connected to at least one of the first wheel and the second wheel to selectively rotate the at least one of the first wheel and the second wheel;
a power source operatively connected to the motor and to the charging portion of the mounting element to provide power thereto;
a control element operatively connected to the motor to selectively provide power to the motor to rotate the at least one of the first wheel and the second wheel;
a charging circuit operatively connected to the power source configured to provide power from an external power source to recharge the power source.

2. The vehicle of claim 1, wherein the steering column includes a pair of opposed handle bars extending from opposite sides thereof.

3. The vehicle of claim 2, wherein the control element is connected to one of the opposed handle bars.

4. The vehicle of claim 2, wherein the mounting element is connected to one of the opposed handle bars.

5. The vehicle of claim 1, further comprising a light mounted on a front of the steering column.

6. The vehicle of claim 1, wherein the light is operatively connected to a controller such that the light is turned on and off based on commands received from the controller.

7. The vehicle of claim 6, wherein the controller comprises a processor of the mobile electronic device received in the mounting device.

8. The vehicle of claim 6, wherein the controller is operatively connected to a processor of the mobile electronic device received in the mounting device.

9. The vehicle of claim 6, wherein the controller is mounted on one of the body and the steering column of the vehicle.

10. The vehicle of claim 6, further comprising a speed sensor configured to provide speed information indicative of a speed of the vehicle, wherein the speed information is provided to the controller.

11. The vehicle of claim 6, wherein the controller receives location information indicative of a current location of the vehicle from the mobile electronic device and determines speed information indicative of a speed of the vehicle based on the location information.

12. The vehicle of claim 6, wherein the controller receives location information indicative a current location of the vehicle and stores the location information.

13. The vehicle of claim 12, wherein the controller provides navigation information indicating an intended route for the vehicle based on the location information and prior location information stored by the controller and provides the navigation information to the mobile electronic device for display on a display of the mobile electronic device.

14. The vehicle of claim 13, wherein the navigation information is provided by the mobile electronic device and displayed on a display of the mobile electronic device.

15. The vehicle of claim 6, wherein speed information indicative of a speed of the vehicle is determined by the mobile electronic device and displayed on a display of the mobile electronic device.

16. The vehicle of claim 1, further comprising a charging port operably connected to the charging circuit and configured to receive a plug connected to the external power source.

17. The vehicle of claim 1, further comprising a transceiver operably connected to the controller such that data is received by and transmitted from the controller.

18. The vehicle of claim 17, wherein the controller receives instruction information from the mobile electronic device and provides instructions to one or more of the motor charging source and power source based on the instruction information.

19. The vehicle of claim 17, wherein the controller provides to the mobile electronic device at least one of speed information, location information, light information and power source status information to the mobile electronic device.

20. The vehicle of claim 1, wherein the mounting device is configured to receive the mobile electronic device without blocking a camera lens integrated into the mobile electronic device.

21. The vehicle of claim 2, further comprising a brake element configured to slow the vehicle.

22. The vehicle of claim 21, further comprising a brake light wherein the brake light is activated when the brake element is activated.

23. The vehicle of claim 21, further comprising a brake actuator positioned on at least one of the opposed handle bars and operably connected to the brake element to selectively engage the brake element.

24. The vehicle of claim 23, wherein the brake actuator is operable connected to the controller and the controller sends instructions to the brake element based on input provided by the brake actuator.

25. The vehicle of claim 2, wherein the connection element is a hinge.
